(19) United States
(12) Patent Application Publication
(10) Pub. No.: US 2019/0003510 A1
(43) Pub. Date: Jan. 3, 2019

(54) FASTENER HAVING A COMPOUND RECESS

(71) Applicants: Carl Chasse, (US); SHEH FUNG SCREWS CO., LTD, Kaohsiung (TW)

(72) Inventors: Carl Chasse, Stafford Springs, CT (US); William R. Lucas, Palos Verdes Estates, CA (US)

(21) Appl. No.: 16/018,494

(22) Filed: Jun. 26, 2018

Related U.S. Application Data
(60) Provisional application No. 62/527,060, filed on Jun. 30, 2017.

(51) Int. Cl. F16B 23/00

(52) U.S. Cl. CPC F16B 23/0092; F16B 23/0038; F16B 23/003

(57) ABSTRACT

A drivable threaded fastener including: a head including a recess; and a shank extending from the head, the recess includes a first recess having a first drive-shape, and a second recess having a second drive-shape different from the first drive-shape, the second recess extends beyond a bottom of the first recess in a direction towards the shank, the first recess is configured to be driven and the second recess is configured to be driven.

### CROSS-REFERENCE TO RELATED APPLICATIONS

This application claims priority to and the benefit of U.S. Provisional Patent Application Ser. No. 62/527,060, filed on Jun. 30, 2017, and all the benefits accruing therefrom under 35 U.S.C. § 119, the content of which is incorporated herein in its entirety by reference.

### BACKGROUND

The subject matter disclosed herein generally relates to rotatably drivable threaded fastener.

Rotatably drivable threaded fasteners are manufactured with a variety of different recess drive-shapes, such as, for example, slotted or cruciform. Each rotatably drivable threaded fastener may utilize a different driver bit to drive the specific rotatably drivable threaded fastener. Each recess drive-shape has benefits that may be favorable for different applications and/or favored in different regions of the world. For example, in the United States consumer market a rotatably drivable threaded fastener having a six-lobe recess drive-shape is widely available. The six-lobe recess allows elevated levels of torque to be applied to the recess through a mating six-lobe driver bit without stripping the six-lobe recess. In another example, in the Canadian consumer market rotatably drivable threaded fasteners having a square recess drive-shape (i.e., the Robertson Square) are widely available. The Robertson square offers great stiction when inserted onto a mating square driver bit, thus enabling one handed fast and accurate installation. The recess of a rotatably drivable threaded fasteners may be stripped when too much torque is applied to the recess by the driver bit, which may subsequently render the rotatably drivable threaded fasteners undrivable and irremovable.

### BRIEF DESCRIPTION

According to an embodiment, a drivable threaded fastener is provided. The drivable threaded fastener including: a head including a recess; and a shank extending from the head, the recess includes a first recess having a first drive-shape, and a second recess having a second drive-shape different from the first drive-shape, the second recess extends beyond a bottom of the first recess in a direction towards the shank, the first recess is configured to be driven and the second recess is configured to be driven.

In addition to one or more of the features described above, or as an alternative, further embodiments may include that the first recess initiates at a top surface of the head and extends into the head to the bottom of the first recess and the second recess initiates at the bottom of the first recess and extends into the head to a bottom of the second recess.

In addition to one or more of the features described above, or as an alternative, further embodiments may include that the bottom of the first recess is located at a first distance away from the top surface, the bottom of the second recess is located at a second distance away from the top surface and a third distance away from the bottom of the first recess, and the first distance is about equal to the third distance.

In addition to one or more of the features described above, or as an alternative, further embodiments may include that the bottom of the first recess is located at a first distance away from the top surface, the bottom of the second recess is located at a second distance away from the top surface, and the second recess has a depth of a third distance and initiates at a fourth distance away from the bottom of the first recess.

In addition to one or more of the features described above, or as an alternative, further embodiments may include that the second recess initiates within the first recess.

In addition to one or more of the features described above, or as an alternative, further embodiments may include that the first drive-shape of the first recess is a lobe recess drive-shape.

In addition to one or more of the features described above, or as an alternative, further embodiments may include that the first drive-shape of the first recess is a six-lobe recess drive-shape.

In addition to one or more of the features described above, or as an alternative, further embodiments may include that the second drive-shape of the second recess is a square recess drive-shape.

In addition to one or more of the features described above, or as an alternative, further embodiments may include that the second drive-shape of the second recess is a square recess drive-shape.

In addition to one or more of the features described above, or as an alternative, further embodiments may include: one or more side walls extending from the top surface of the head to the bottom of the first recess and forming the first drive-shape of the first recess, wherein each of the one or more side walls is parallel to a longitudinal axis of the drivable threaded fastener.

In addition to one or more of the features described above, or as an alternative, further embodiments may include: one or more side walls extending from the bottom of the first recess to the bottom of the second recess and forming the second drive-shape of the second recess, wherein each of the one or more side walls is parallel to a longitudinal axis of the drivable threaded fastener.

In addition to one or more of the features described above, or as an alternative, further embodiments may include: one or more side walls extending from the top surface of the head to the bottom of the first recess and forming the first drive-shape of the first recess, wherein at least one of the one or more side walls is non-parallel to a longitudinal axis of the drivable threaded fastener.

In addition to one or more of the features described above, or as an alternative, further embodiments may include: one or more side walls extending from the bottom of the first recess to the bottom of the second recess and forming the second drive-shape of the second recess, wherein at least one of the one or more side walls is non-parallel to a longitudinal axis of the drivable threaded fastener.

In addition to one or more of the features described above, or as an alternative, further embodiments may include: one or more side walls extending from the bottom of the first recess to the bottom of the second recess and forming the second drive-shape of the second recess, wherein at least one of the one or more side walls forming the second drive-shape is non-parallel to the longitudinal axis of the drivable threaded fastener.

In addition to one or more of the features described above, or as an alternative, further embodiments may include: one or more side walls extending from the bottom of the first recess to the bottom of the second recess and forming the second drive-shape of the second recess, wherein at least one of the one or more side walls forming the second drive-shape is non-parallel to a longitudinal axis of the drivable threaded fastener.

In addition to one or more of the features described above, or as an alternative, further embodiments may include that the head is a flat head, a round head, an oval head, a button head, a round head, a truss head, a binding head, a PF head, a cheese head, a fillister head, a pan washer head, a buglehead, a flanged head, a cylinder head, a hexagon head, an indented hexagon head, a washer head, or a pan head.

In addition to one or more of the features described above, or as an alternative, further embodiments may include that the head is a flat head.

In addition to one or more of the features described above, or as an alternative, further embodiments may include that the first drive-shape of the first recess is a slot, a cross, a Phillips, a Frearson, a French, a JISB1012, a Mortorq, a Pozidriv, a torq-set, a Phillips/slotted, a square, a Robertson, a hex, a 12-point, hex socket, a security hex, a double-square, a triple-square, a 12-spline flange, a double hex, a torx, security torx, a torx plus, a polydrive, an external torx, a line head male, a line head female, a line head female tamper, a TA, a Tri-point, a Tri-groove, a tri-wind, a clutch A, a clutch G, a one way, a Bristol, a quadrex, a pentalobe, or a spanner head.

In addition to one or more of the features described above, or as an alternative, further embodiments may include that the second drive-shape of the second recess is a slot, a cross, a Phillips, a Frearson, a French, a JISB1012, a Mortorq, a Pozidriv, a torq-set, a Phillips/slotted, a square, a Robertson, a hex, a 12-point, hex socket, a security hex, a double-square, a triple-square, a 12-spline flange, a double hex, a torx, security torx, a torx plus, a polydrive, an external torx, a line head male, a line head female, a line head female tamper, a TA, a Tri-point, a Tri-groove, a tri-wind, a clutch A, a clutch G, a one way, a Bristol, a quadrex, a pentalobe, or a spanner head.

In addition to one or more of the features described above, or as an alternative, further embodiments may include that the square recess drive-shape includes two sides oriented at an angle between 0° and 45° relative to a lateral axis of the threaded fastener, the lateral axis bisects the six-lobe recess drive-shape and extends from a first lobe vertex of the six-lobe recess drive-shape to a second lobe vertex of the six-lobe recess drive-shape opposite the first lobe vertex.

According to another embodiment, a drivable threaded fastener is provided. The drivable threaded fastener including: a head including an upper end, a lower end opposite the upper end, and a top surface at the upper end; a shank attached to the lower end of the head; and a stacked compound recess formed on the top surface, the stacked compound recess including: a first recess having a first drive-shape, the first recess being located on a first plane of the stacked compound recess; and a second recess having a second drive-shape different from the first drive-shape, the second recess being located on a second plane of the stacked compound recess, the second plane is different from the first plane, the first recess is configured to be driven and the second recess is configured to be driven.

In addition to one or more of the features described above, or as an alternative, further embodiments may include that the second plane is parallel to the first plane.

In addition to one or more of the features described above, or as an alternative, further embodiments may include that the first plane is perpendicular to a longitudinal axis of the drivable threaded fastener.

In addition to one or more of the features described above, or as an alternative, further embodiments may include that the first plane is located at a first distance away from the top surface, the second plane is located at a second distance away from the top surface and a third distance away from the second plane, and the first distance is equal to the third distance.

In addition to one or more of the features described above, or as an alternative, further embodiments may include that the first plane is located at a first distance away from the top surface, the second plane is located at a second distance away from the top surface and a third distance away from the second plane, and the second recess initiates at a fourth distance away from the first plane.

In addition to one or more of the features described above, or as an alternative, further embodiments may include that the second recess initiates within the first recess.

In addition to one or more of the features described above, or as an alternative, further embodiments may include that the first drive-shape of the first recess is a lobe recess drive-shape.

In addition to one or more of the features described above, or as an alternative, further embodiments may include that the first drive-shape of the first recess is a six-lobe recess drive-shape.

In addition to one or more of the features described above, or as an alternative, further embodiments may include that the second drive-shape of the second recess is a square recess drive-shape.

In addition to one or more of the features described above, or as an alternative, further embodiments may include that the second drive-shape of the second recess is a square recess drive-shape.

According to another embodiment, a drivable threaded fastener is provided. The drivable threaded fastener including: a flat head including a recess; and a shank extending from the flat head, the shank including a threaded portion, the recess includes a first recess having a six-lobe recess, and a second recess having a square recess drive-shape, the second recess extends beyond a bottom of the first recess in a direction towards the shank, the first recess is configured to be driven and the second recess is configured to be driven, the first recess initiates at a top surface of the head and extends into the head to the bottom of the first recess and the second recess initiates at the bottom of the first recess and extends into the head to a bottom of the second recess, the bottom of the first recess is located at a first distance away from the top surface, the bottom of the second recess is located at a second distance away from the top surface and a third distance away from the bottom of the first recess, and the first distance is about equal to the third distance.

According to another embodiment, a method of forming a stacked compound recess in a head of a fastener. The method including: forming a first recess having a first drive-shape and a second recess having a second drive-shape different from the first drive-shape, the second recess extends beyond a bottom of the first recess in a direction towards a shank of the fastener, the first recess is configured to be driven and the second recess is configured to be driven.

### BRIEF DESCRIPTION OF THE DRAWINGS

The following descriptions should not be considered limiting in any way. With reference to the accompanying drawings, like elements are numbered alike:

FIG. 1 illustrates a drivable threaded fastener, in accordance with an embodiment of the disclosure;

FIG. 2 illustrates an enlarged view of a head of the drivable threaded fastener of FIG. 1 having a flat head, in accordance with an embodiment of the disclosure;

FIG. 3 illustrates a top view of a head of the drivable threaded fastener of FIG. 1, in accordance with an embodiment of the disclosure;

FIG. 4 illustrates an isometric cross-sectional view of the head of the drivable threaded fastener of FIG. 3, in accordance with an embodiment of the disclosure;

FIG. 5 illustrates an enlarged view of a head of the drivable threaded fastener of FIG. 1 having a round head, in accordance with an embodiment of the disclosure;

FIG. 6 illustrates an enlarged view of a head of the drivable threaded fastener of FIG. 1, in accordance with an embodiment of the disclosure;

FIG. 7 illustrates an enlarged view of a head of the drivable threaded fastener of FIG. 1, in accordance with an embodiment of the disclosure; and

FIG. 8 illustrates a top view of a head of the drivable threaded fastener of FIG. 1, in accordance with an embodiment of the disclosure.

### DETAILED DESCRIPTION

A detailed description of one or more embodiments of the disclosed apparatus and method are presented herein by way of exemplification and not limitation with reference to the Figures.

As noted above, the six-lobe recess is widely available in the United States and the Robertson square configuration is widely available in Canada. A configuration which can accept either a square or six-lobe driver bit would be desirable. A current fastener having the six-lobe recess may not be driven by a square driver bit, and a current fastener having a square recess may not be driven by a six-lobe driver bit without the risk of potentially stripping the respective recess. Also, because the six-lobe recess and the square recess occupy much of the same space (or a considerable overlapping space), a simple combination of the six-lobe recess and the square recess does not provide a usable recess by either a six-lobe or a square driver bit.

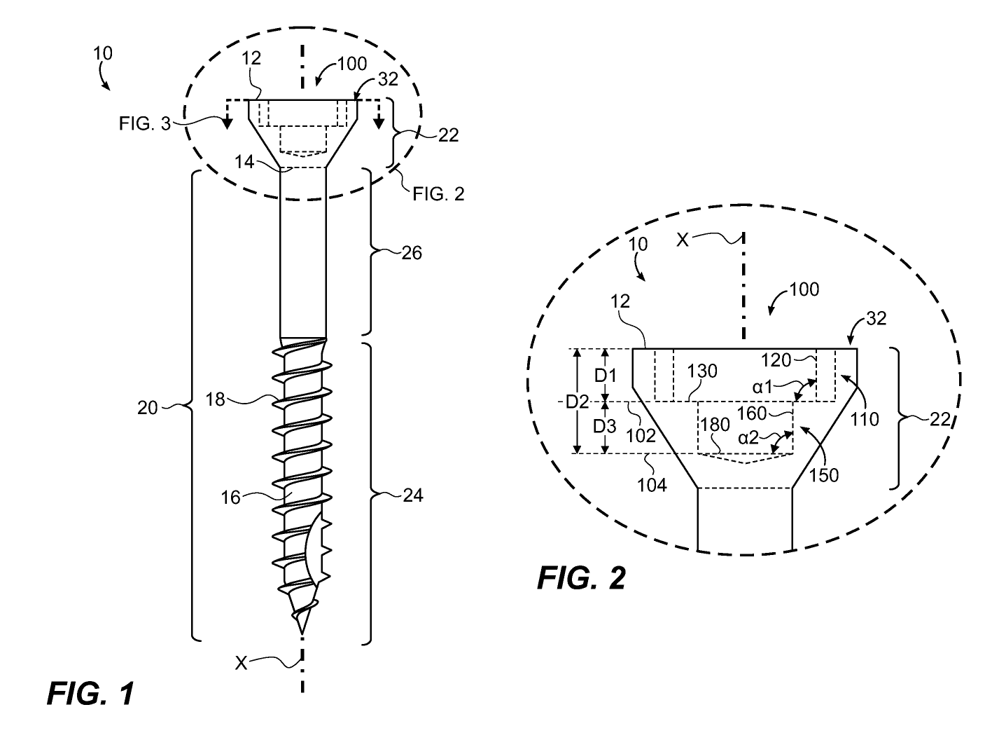

FIG. 1 schematically illustrates a drivable threaded fastener 10. The threaded fastener 10 includes shank 20 and a head 22. A head 22 head includes an upper end 12 and a lower end 14 opposite the upper end 12. The shank 20 extends from the lower end 14 of the head 22. The shank 20 may be attached to the head 22 at the lower end 14 of the head 22 or formed with the head 22 at the lower end 14 of the head 22. The shank 20 includes a threaded portion 24. The threaded portion 24 includes a thread 18 helically wrapped around a shaft 16 of the shank 20. The thread 18 may be wrapped around the shaft 15 such that the threaded fastener 10 right-handed or left-handed. There may be a non-threaded portion 26 interposed between the threaded portion 24 and the lower end 14 of the head 22 of the threaded fasteners 10, as shown in FIG. 1.

In an embodiment, the head 22 of the threaded fasteners 12 may be a flat head, as illustrated in FIG. 1. It is understood that while a flat head is utilized for exemplary illustration, embodiments disclosed herein may be applied to other head types such as, for example, oval, button, round, truss, binding, PF, cheese, fillister, pan washer, bugle, flanged, cylinder, hexagon, indented hexagon, washer, pan (JIS), or pan (AISI) configurations. FIG. 2 illustrates a threaded fastener 10 having a head 32 that is flat and FIG. 5 illustrates a threaded fastener 10 having a head 32 that is round. The head 22 includes a top surface 32 located at the first end 12 of the head 22. The top surface 32 may be a substantially flat surface oriented about perpendicular with a longitudinal axis X of the drivable threaded fastener 10. The head 22 of the threaded fastener 10 includes a stacked compound recess 100 formed on the top surface 32. The stacked compound recess 100 is formed in the top surface 32 of the head 22 and extends into the head 22.

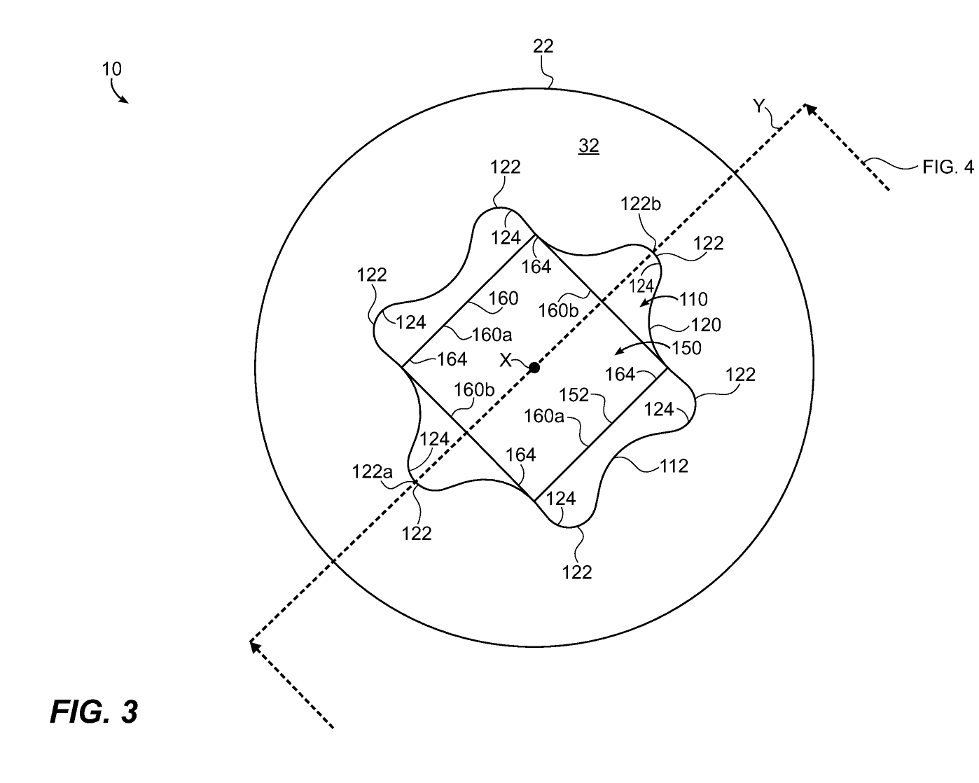

Referring now to FIGS. 2-8, with continued reference to FIG. 1, the stacked compound recess 100 includes a first recess 110 having a first drive-shape 112 and a second recess 150 having a second drive-shape 152. In an embodiment, the first recess 110 is configured to be driven (i.e., drivable by a mating tool) and the second recess 150 is configured to be driven, such that the first recess 110 and the second recess 150 may be driven independently and/or in combination using a tool having a drive-shape that mates to the first recess 110 and/or the second recess 150. In order to be configured to be driven, each recess 110, 150 may have a non-circular shape with at least one contact point suitable to provide torque to the threaded fastener 10, such as, for example contact points 124, 164 as shown in FIG. 3. Each contact point 124, 164 may be non-parallel to a tangent vector of a circular rotational path around the longitudinal axis X. In another embodiment, the second drive-shape 152 is different than (i.e., non-equivalent to) the first drive-shape 112. The drive-shape of the first recess or the second recess may be a slot, a cross, a Phillips, a Frearson, a French, a JISB1012, a Mortorq, a Pozidriv, a torq-set, a Phillips/slotted, a square, a Robertson, a hex, a 12-point, hex socket, a security hex, a double-square, a triple-square, a 12-spline flange, a double hex, a torx, security torx, a torx plus, a polydrive, an external torx, a line head male, a line head female, a line head female tamper, a TA, a Tri-point, a Tri-groove, a tri-wind, a clutch A, a clutch G, a one way, a Bristol, a quadrex, a pentalobe, or a spanner head. As shown in FIG. 3, the first drive-shape 112 may be a six-lobe recess drive-shape and the second drive-shape 152 may be a square recess drive-shape. In an embodiment, the second drive-shape 152 of the second recess 150 may be different than the first drive-shape 112 of the first recess 110. In another embodiment, the second drive-shape 152 of the second recess 150 may be the same as the first drive-shape 112 of the first recess 110 however the size of the second drive-shape 152 may be different from the first drive-shape. In an embodiment, the first drive-shape 112 of the first recess 110 is a lobe recess drive-shape. In another embodiment, the first drive-shape 112 of the first recess 110 is a six-lobe recess drive-shape, as shown in FIG. 3. In yet another embodiment, the second drive-shape 152 of the second recess 150 is a square recess (e.g., a Robertson recess), as shown in FIG. 3. Advantageously, since the second recess 150 has a different drive-shape than the first recess 110, the threaded fastener 10 may be driven by different driver bits, e.g., a driver bit having the first drive-shape, a driver bit having the second drive-shape, or a driver bit with a combination of the first drive-shape and the second drive-shape.

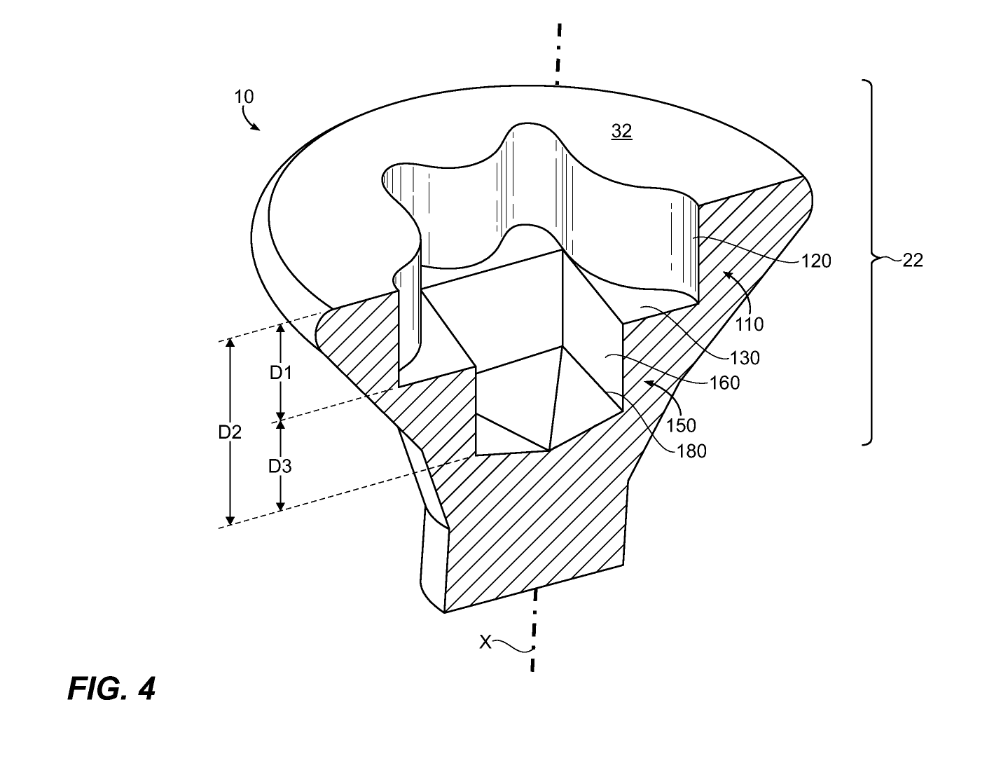

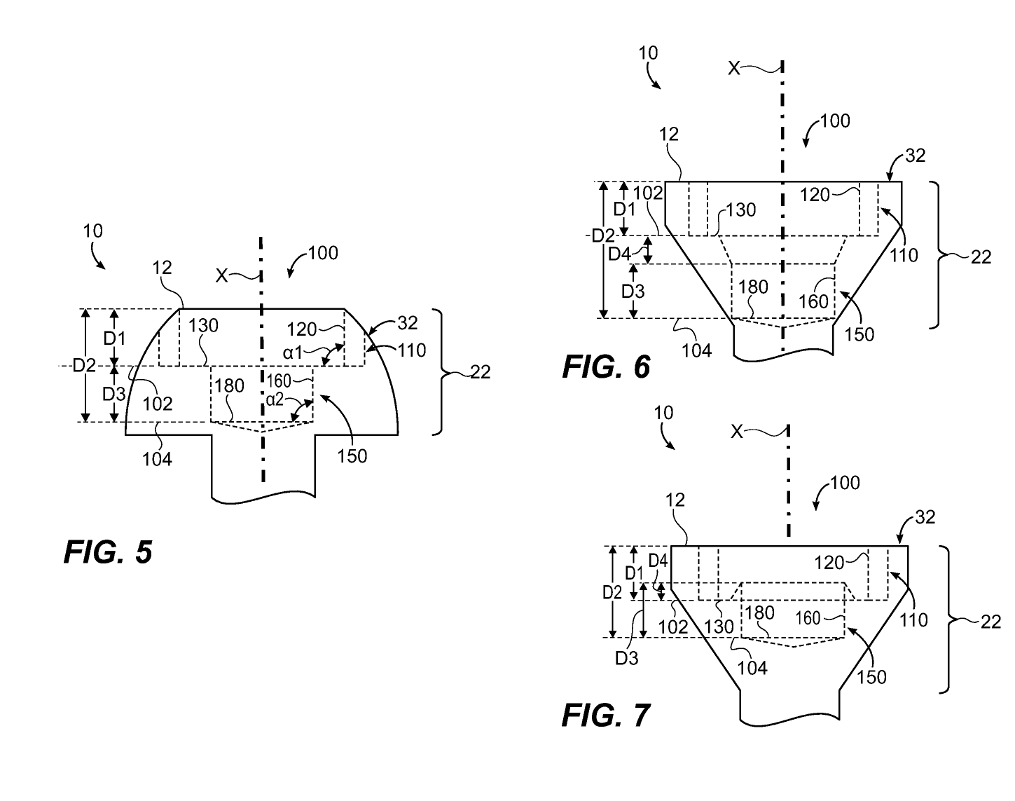

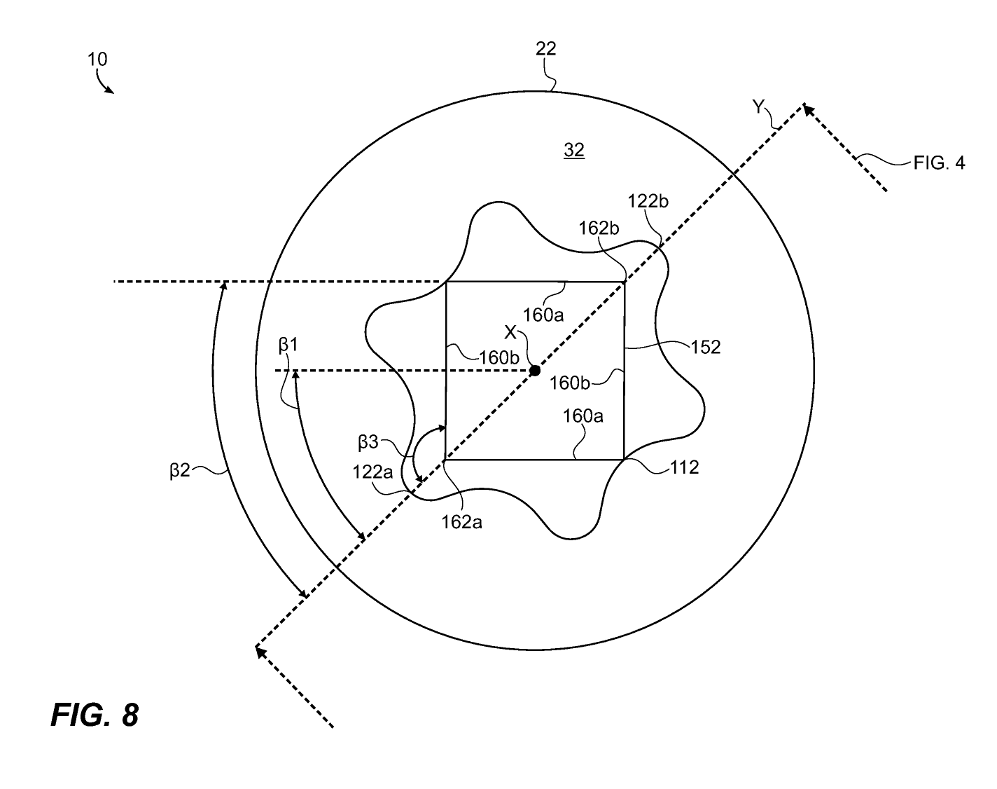

The first recess 110 and the second recess 150 may be located on different planes 102, 104 of the stacked compound recess 100 relative to a longitudinal axis X of the drivable threaded fastener 10, as shown in FIGS. 2 and 4. Advantageously, since the first recess 110 and the second recess 150 are located on different planes 102, 104, one recess may be driven independently of the other recess. Also advantageously, since the first recess 110 and the second recess 150 are located on different planes 102, 104, if one recess were to be stripped, the other recess may be utilized to drive the threaded fastener 10. Further advantageously, since the first recess 110 and the second recess 150 are located on different planes 102, 104, if a first driver bit were to become stripped driving one recess, the other recess may be driven by a second driver bit.

FIG. 2 illustrates a threaded fastener 10 having a head 32 that is flat and FIG. 5 illustrates a threaded fastener 10 having a head 32 that is round. As shown in FIG. 2, the first recess 110 is located on a first plane 102 of the stacked compound recess 100. The first plane 102 is located at a first distance D1 away from the top surface 32 as measured linearly along the longitudinal axis X of the drivable threaded fastener 10. The first recess 110 has a depth equivalent to the first distance D1. The first plane 102 may be oriented perpendicular to the longitudinal axis X of the threaded fastener 10. As shown in FIG. 2, the second recess 150 is located on a second plane 104 of the stacked compound recess 100. The second plane 102 may be oriented perpendicular to the longitudinal axis X of the threaded fastener 10. The second plane 104 may be oriented parallel to the first plane 102. The second plane 104 is located at a second distance D2 away from the top surface 32 as measured linearly along the longitudinal axis X of the drivable threaded fastener 10. The second recess 150 has a depth of a third distance D3, which is equivalent to the second distance D2 minus the first distance D1. A ratio of the first distance D1 to third distance D3 (i.e., D1/D3) may be between 1:10 to 10:1, 2:8 to 8:2, 3:7 to 7:3, or 4:6 to 6:4. In an embodiment, the ratio of the first distance D1 to third distance D3 (i.e., D1/D3) is equal to 1. A ratio of the third distance D3 to the first distance D1 (i.e., D3/D1) may be between 1:10 to 10:1, 2:8 to 8:2, 3:7 to 7:3, or 4:6 to 6:4. In an embodiment, the ratio of the third distance D3 to the first distance D1 (i.e., D3/D1) is equal to 1. In an embodiment, the depth of the second recess 150 is about equal to the depth of the first recess 110, thus the third distance D3 is about equal to the first distance D1. Further advantageously, since the depth (i.e., distance D1) of the first recess 110 and is about equal to the depth (i.e., distance D3) of the second recess 150, it prevents one recess from becoming engaged prior to the other recess, thus allowing simultaneous engagement of the first recess 110 and the second recess 150 when being driven by a bit that mates with both the first recess 110 and the second recess 150.

The first recess 110 initiates at a top surface 32 of the head 22 and extends into the head 22 to a bottom 130 of the first recess 110. In an embodiment, the second recess may initiate at the bottom 130 of the first recess 110 and extend into the head 22 to a bottom 180 of the second recess 150, as shown in FIG. 2. In another embodiment, the second recess may initiate a fourth distance D4 away from the bottom 130 of the first recess 110 and extend into the head 22 to a bottom 180 of the second recess 150, as shown in FIG. 6. In an embodiment, the fourth distance D4 may be negative and the second recess 150 may overlap with the first recess 110, as shown in FIG. 7. In another embodiment, the second recess 150 may initiate within the first recess 110, as shown in FIG. 7. A ratio of the fourth distance D4 to first distance D1 (i.e., D4/D1) may be equal to 1/10, 2/8, 3/7, 1/2, or 1/1.

The first recess 110 includes one or more side walls 120 extending from the top surface 32 of the head 22 to a bottom 130 of the first recess 110 located at the first plane 102. The one or more side walls 120 of the first recess 110 form the first drive-shape 112 of the first recess 110. The one or more side walls 120 of the first recess 110 may be about parallel relative to the longitudinal axis X of the threaded fastener 10, as shown in FIGS. 2 and 4. In an embodiment, at least one of the one or more side walls 120 of the first recess 110 may be non-parallel relative to the longitudinal axis X of the threaded fastener 10. In an embodiment, at least one of the one or more side walls 120 of the first recess 110 may be oriented at first angle α1 that is non-perpendicular relative to the bottom 130 of the first recess 110.

The second recess 150 includes one or more side walls 160 extending from the bottom 130 of the first recess 110 to a bottom 180 of the second recess 150 located at the second plane 104. The one or more side walls 160 of the second recess 150 form the second drive-shape 152 of the second recess 150. The one or more side walls 160 of the second recess 150 may be about parallel relative to the longitudinal axis X of the threaded fastener 10, as shown in FIGS. 2 and 4. In an embodiment, at least one of the one or more side walls 160 of the second recess 150 may be non-parallel relative to the longitudinal axis X of the threaded fastener 10. Advantageously, orienting the one or more side walls 120 of the first recess 110 or the one or more side walls 160 of the second recess 150 at a non-parallel angle relative to the longitudinal axis X of the threaded fastener 10 produces a non-magnetic stick fit on a bit that mates with both the first recess 110 and the second recess 150.

In an embodiment, each of the one or more side walls 160 of the second recess 150 may be oriented at second angle α2 that is non-perpendicular relative to the bottom 180 of the second recess 150. In an embodiment, at least one of the one or more side walls 160 of the second recess 150 may be oriented at second angle α2 that not equivalent to the first angle α1. Advantageously, the second angle α2 being different from the first angle α1 produces a non-magnetic stick fit on a bit that mates with both the first recess 110 and the second recess 150. The second angle α2 is between 0° to 10°; 1° to 8°; or 2° to 6°. In an embodiment, the second angle α2 is between 1.5° to 2°. In another embodiment, the first angle α1 is 0°.

The stacked compound recess 100 in the top surface 32 of the head 22 of the threaded fastener 10 may be seen in FIG. 3. In the illustrated embodiment of FIG. 3, the first drive-shape 112 of the first recess 110 is a six-lobe recess drive-shape having six lobes 122 and the second drive-shape 152 of the second recess 150 is a square recess drive-shape. The first drive-shape 112 may be formed by one or more side walls 120. In an embodiment, the first drive-shape is formed by one curved side wall 120, as shown in FIG. 3. The second drive-shape 152 is formed by four side walls 160, as shown in FIG. 3.

The first drive-shape 112 being a six-lobe recess drive-shape provides six contact points 124 for a mating six-lobe driver bit to apply a torque to rotate the threaded fastener 10 at the first recess 110. The second drive-shape 152 being a square recess drive-shape provides four contact points 164 for a mating square driver bit to apply a torque to rotate the threaded fastener 10 at the second recess 150. The threaded fastener 10 may be driven through contacts points 124 of the first recess 110 and/or the contact point 164 of the second recess 150. Advantageously, the stacked compound recess 100 may be driven by a single stacked compound driver bit that includes a six-lobe driver bit to mate with the first recess 110 and a square driver bit to mate with the second recess 150, which provides a total of 10 contact points 124, 164 to transfer torque from the single stacked compound driver bit to the stacked compound recess 100, thus increasing the driving force on the threaded fastener 10.

It is understood that while the contact points 124, 164 in FIG. 3 illustrated a right-handed threaded fastener 10, embodiments disclosed herein may also be applicable to a left handed threaded fastener 10. It is further understood that the contact points 124, 164 in FIG. 3 are approximate contact points for a potential mating driver bit, which are utilized for illustrative purposes and thus may vary in location and size.

The second drive-shape 152 may be oriented relative to the first drive-shape 112, as shown in FIG. 3. A lateral axis Y of the threaded fastener 10 bisects the six-lobe recess drive-shape of the first draft-shape 112 and extends from a first lobe vertex 122a to a second lobe vertex 122b opposite the first lobe vertex 122a. In a first position, as shown in FIG. 3, the square recess drive-shape of the second drive-shape 152 may have two sides 160a oriented parallel with the lateral axis Y and two sides 160b oriented perpendicular with the lateral axis Y. The square recess drive-shape of the second drive-shape 152 may be oriented at an angle relative to the lateral axis Y between the first position shown in FIG. 3 and a second position shown in FIG. 8.

In the second position, shown in FIG. 8, the square recess drive-shape of the second drive-shape 152 may be located at an angle β1 of about 45° relative to the lateral axis, as measured around the longitudinal axis X. In an embodiment, the square recess drive-shape of the second drive-shape 152 may be oriented between an angle β1 of 0° relative to the lateral axis Y (as shown in FIG. 3) and an angle β1 of 45° relative to the lateral axis Y (as shown in FIG. 8). In another embodiment, the square recess drive-shape of the second drive-shape 152 may be oriented at an angle β1 of 0° relative to the lateral axis Y, as shown in FIG. 3. In another embodiment, the square recess drive-shape of the second drive-shape 152 may be oriented at an angle β1 of 45° relative to the lateral axis Y, as shown in FIG. 8. In another embodiment, the square recess drive-shape of the second drive-shape 152 may be oriented at an angle β1 of −45° (i.e., 315°) relative to the lateral axis Y, as shown in FIG. 8.

In the second position, as shown in FIG. 8, the square recess drive-shape of the second drive-shape 152 may have two sides 160a oriented at an angle β2 of 45° relative to the lateral axis Y and two sides 160b oriented an angle β3 of 120° relative to the lateral axis Y. In an embodiment, two sides 160a of the square recess drive-shape of the second drive-shape 152 be oriented at an angle β2 of 0° and an angle β2 of 45° relative to the lateral axis Y.

Further, the square recess drive-shape of the second drive-shape 152 may have any suitable orientation relative to the six-lobe recess drive-shape of the first drive-shape 112. The square recess drive-shape of the second drive-shape 152 may be oriented such that a first vertex 162a of the square recess drive-shape and a second vertex 162b of the square recess drive-shape are located on the lateral axis Y (i.e., the second position in FIG. 8), or the square recess drive-shape of the second drive-shape 152 is rotated 0° to 45°, 5° to 40°, or 10° to 30° relative to the second position shown in FIG. 8.

In an embodiment, the square recess 150 may be sized to fit within the six-lobe recess 110, as shown in FIG. 8. In another embodiment, the square recess 150 may be sized to allow for overlap of the six-lobe recess 110 and the square recess 150, as shown in FIG. 8.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A drivable threaded fastener, comprising:
a head comprising a recess; and
a shank extending from the head,
wherein the recess comprises a first recess having a first drive-shape, and a second recess having a second drive-shape different from the first drive-shape,
wherein the second recess extends beyond a bottom of the first recess in a direction towards the shank,
wherein the first recess is configured to be driven and the second recess is configured to be driven.

2. The drivable threaded fastener of claim 1, wherein the first recess initiates at a top surface of the head and extends into the head to the bottom of the first recess and the second recess initiates at the bottom of the first recess and extends into the head to a bottom of the second recess.

3. The drivable threaded fastener of claim 1, wherein the bottom of the first recess is located at a first distance away from the top surface, wherein the bottom of the second recess is located at a second distance away from the top surface and a third distance away from the bottom of the first recess, and wherein the first distance is about equal to the third distance.

4. The drivable threaded fastener of claim 1, wherein the bottom of the first recess is located at a first distance away from the top surface, wherein the bottom of the second recess is located at a second distance away from the top surface, and wherein the second recess has a depth of a third distance and initiates at a fourth distance away from the bottom of the first recess.

5. The drivable threaded fastener of claim 1, wherein the second recess initiates within the first recess.

6. The drivable threaded fastener of claim 1, wherein the first drive-shape of the first recess is a lobe recess drive-shape.

7. The drivable threaded fastener of claim 1, wherein the first drive-shape of the first recess is a six-lobe recess drive-shape.

8. The drivable threaded fastener of claim 1, wherein the second drive-shape of the second recess is a square recess drive-shape.

9. The drivable threaded fastener of claim 7, wherein the second drive-shape of the second recess is a square recess drive-shape.

10. The drivable threaded fastener of claim 1, further comprising:
one or more side walls extending from the top surface of the head to the bottom of the first recess and forming the first drive-shape of the first recess, wherein each of the one or more side walls is parallel to a longitudinal axis of the drivable threaded fastener.

11. The drivable threaded fastener of claim 2, further comprising:
one or more side walls extending from the bottom of the first recess to the bottom of the second recess and forming the second drive-shape of the second recess, wherein each of the one or more side walls is parallel to a longitudinal axis of the drivable threaded fastener.

12. The drivable threaded fastener of claim 1, further comprising:
one or more side walls extending from the top surface of the head to the bottom of the first recess and forming the first drive-shape of the first recess, wherein at least one of the one or more side walls is non-parallel to a longitudinal axis of the drivable threaded fastener.

13. The drivable threaded fastener of claim 2, further comprising:
one or more side walls extending from the bottom of the first recess to the bottom of the second recess and forming the second drive-shape of the second recess, wherein at least one of the one or more side walls is non-parallel to a longitudinal axis of the drivable threaded fastener.

14. The drivable threaded fastener of claim 10, further comprising:
one or more side walls extending from the bottom of the first recess to the bottom of the second recess and forming the second drive-shape of the second recess, wherein at least one of the one or more side walls forming the second drive-shape is non-parallel to the longitudinal axis of the drivable threaded fastener.

15. The drivable threaded fastener of claim 12, further comprising:
one or more side walls extending from the bottom of the first recess to the bottom of the second recess and forming the second drive-shape of the second recess, wherein at least one of the one or more side walls forming the second drive-shape is non-parallel to a longitudinal axis of the drivable threaded fastener.

16. The drivable threaded fastener of claim 1, wherein the head is a flat head, a round head, an oval head, a button head, a round head, a truss head, a binding head, a PF head, a cheese head, a fillister head, a pan washer head, a buglehead, a flanged head, a cylinder head, a hexagon head, an indented hexagon head, a washer head, or a pan head.

17. The drivable threaded fastener of claim 1, wherein the head is a flat head.

18. The drivable threaded fastener of claim 1, wherein the first drive-shape of the first recess is a slot, a cross, a Phillips, a Frearson, a French, a JISB1012, a Mortorq, a Pozidriv, a torq-set, a Phillips/slotted, a square, a Robertson, a hex, a 12-point, hex socket, a security hex, a double-square, a triple-square, a 12-spline flange, a double hex, a torx, security torx, a torx plus, a polydrive, an external torx, a line head male, a line head female, a line head female tamper, a TA, a Tri-point, a Tri-groove, a tri-wind, a clutch A, a clutch G, a one way, a Bristol, a quadrex, a pentalobe, or a spanner head.

19. The drivable threaded fastener of claim 1, wherein the second drive-shape of the second recess is a slot, a cross, a Phillips, a Frearson, a French, a JISB1012, a Mortorq, a Pozidriv, a torq-set, a Phillips/slotted, a square, a Robertson, a hex, a 12-point, hex socket, a security hex, a double-square, a triple-square, a 12-spline flange, a double hex, a torx, security torx, a torx plus, a polydrive, an external torx, a line head male, a line head female, a line head female tamper, a TA, a Tri-point, a Tri-groove, a tri-wind, a clutch A, a clutch G, a one way, a Bristol, a quadrex, a pentalobe, or a spanner head.

20. The drivable threaded fastener of claim 9, wherein the square recess drive-shape includes two sides oriented at an angle between 0° and 45° relative to a lateral axis of the threaded fastener, wherein the lateral axis bisects the six-lobe recess drive-shape and extends from a first lobe vertex of the six-lobe recess drive-shape to a second lobe vertex of the six-lobe recess drive-shape opposite the first lobe vertex.

21. A drivable threaded fastener, comprising:
a head including an upper end, a lower end opposite the upper end, and a top surface at the upper end;
a shank attached to the lower end of the head; and
a stacked compound recess formed on the top surface, the stacked compound recess comprising:
a first recess having a first drive-shape, the first recess being located on a first plane of the stacked compound recess; and
a second recess having a second drive-shape different from the first drive-shape, the second recess being located on a second plane of the stacked compound recess,
wherein the second plane is different from the first plane,
wherein the first recess is configured to be driven and the second recess is configured to be driven.

22. The drivable threaded fastener of claim 21, wherein the second plane is parallel to the first plane.

23. The drivable threaded fastener of claim 22, wherein the first plane is perpendicular to a longitudinal axis of the drivable threaded fastener.

24. The drivable threaded fastener of claim 21, wherein the first plane is located at a first distance away from the top surface, wherein the second plane is located at a second distance away from the top surface and a third distance away from the second plane, and wherein the first distance is equal to the third distance.

25. The drivable threaded fastener of claim 21, wherein the first plane is located at a first distance away from the top surface, wherein the second plane is located at a second distance away from the top surface and a third distance away from the second plane, and wherein the second recess initiates at a fourth distance away from the first plane.

26. The drivable threaded fastener of claim 21, wherein the second recess initiates within the first recess.

27. The drivable threaded fastener of claim 21, wherein the first drive-shape of the first recess is a lobe recess drive-shape.

28. The drivable threaded fastener of claim 27, wherein the first drive-shape of the first recess is a six-lobe recess drive-shape.

29. The drivable threaded fastener of claim 21, wherein the second drive-shape of the second recess is a square recess drive-shape.

30. The drivable threaded fastener of claim 28, wherein the second drive-shape of the second recess is a square recess drive-shape.

31. A drivable threaded fastener, comprising:
a flat head comprising a recess; and
a shank extending from the flat head, the shank comprising a threaded portion,
wherein the recess comprises a first recess having a six-lobe recess, and a second recess having a square recess drive-shape,
wherein the second recess extends beyond a bottom of the first recess in a direction towards the shank,
wherein the first recess is configured to be driven and the second recess is configured to be driven,
wherein the first recess initiates at a top surface of the head and extends into the head to the bottom of the first recess and the second recess initiates at the bottom of the first recess and extends into the head to a bottom of the second recess,
wherein the bottom of the first recess is located at a first distance away from the top surface, wherein the bottom of the second recess is located at a second distance away from the top surface and a third distance away from the bottom of the first recess, and wherein the first distance is about equal to the third distance.

32. A method of forming a stacked compound recess in a head of a fastener, the method comprising:
forming a first recess having a first drive-shape and a second recess having a second drive-shape different from the first drive-shape,
wherein the second recess extends beyond a bottom of the first recess in a direction towards a shank of the fastener,
wherein the first recess is configured to be driven and the second recess is configured to be driven.
